(19) United States
(12) Patent Application Publication
(10) Pub. No.: US 2018/0278679 A1
(43) Pub. Date: Sep. 27, 2018

(54) Methods, Apparatus and Systems For Information-Centric Networking (ICN) Based Surrogate Server Management Under Dynamic Conditions And Varying Constraints

(71) Applicant: IDAC Holdings, Inc., Wilmington, DE (US)

(72) Inventors: Onur Sahin, London (GB); Dirk Trossen, London (GB)

(21) Appl. No.: 15/764,772

(22) PCT Filed: Sep. 23, 2016
(86) PCT No.: PCT/US2016/053340

§ 371 Date: Mar. 29, 2018

Related U.S. Application Data
(60) Provisional application No. 62/236,327, filed on Oct. 2, 2015.

(51) Int. Cl. H04L 29/08; G06F 9/455; G06F 9/48

(52) U.S. Cl. CPC H04L 67/1031; H04L 67/1029; G06F 2009/45575; G06F 9/485; G06F 9/45558

(57) ABSTRACT

Methods, apparatus and systems for surrogate server management in an ICN network is disclosed. One representative method may include subscribing, by a network entity, to attribute information to be published; obtaining, by the network entity, the published attribute information; determining, by the network entity, based on the obtained attribute information, whether to activate a virtual machine (VM) to be executed in a surrogate server or to deactivate the VM executing in the surrogate server; and sending, by the network entity to a second network entity, a command to activate or deactivate the VM.

### CROSS REFERENCE TO RELATED APPLICATIONS

This application claims priority from U.S. Provisional Application No. 62/236,327, filed Oct. 2, 2015, the contents of which are incorporated herein by reference.

### FIELD

The present invention relates to the field of wireless communications and ICNs and, more particularly, to methods, apparatus and systems for use with ICNs.

### BACKGROUND

The Internet may be used to facilitate content distribution and retrieval. In existing Internet protocol (IP) networks, computing nodes are interconnected by establishing communications using IP addresses of these nodes. In ICNs, users are interested in the content itself. Content distribution and retrieval may be performed by ICNs based on names (i.e., identifiers (IDs)) of content, rather than IP addresses.

### BRIEF DESCRIPTION OF THE DRAWINGS

A more detailed understanding may be had from the Detailed Description below, given by way of example in conjunction with drawings appended hereto. Figures in such drawings, like the detailed description, are examples. As such, the Figures and the detailed description are not to be considered limiting, and other equally effective examples are possible and likely. Furthermore, like reference numerals in the Figures indicate like elements, and wherein:

FIG. 1A is a system diagram illustrating a representative communication system in which various embodiments may be implemented;

FIG. 1B is a system diagram illustrating a representative wireless transmit/receive unit (WTRU) that may be used within the communication system illustrated in FIG. 1A;

FIG. 1C is a system diagram illustrating a representative radio access network (RAN) and a representative core network (CN) that may be used within the communication system illustrated in FIG. 1A;

FIG. 2 is a block diagram illustrating a representative ICN network architecture including surrogate servers;

FIG. 3 is a block diagram illustrating a representative surrogate server;

FIG. 4 is a diagram illustrating a representative namespace;

FIG. 5 is a message sequence chart illustrating representative messaging operations in the ICN.

FIG. 6 is a flowchart illustrating a representative method of surrogate server management in a ICN network;

FIG. 7 is a flowchart illustrating a representative method of managing a namespace in a rendezvous server/node (RV); and

FIG. 8 is a flowchart illustrating a representative method for an Information-Centric Networking (ICN) network.

### DETAILED DESCRIPTION

Although the detailed description is illustrated and described herein with reference to specific embodiments, the invention is not intended to be limited to the details shown. Rather, various modifications may be made in the details within the scope and range of equivalents of the claims and without departing from the invention.

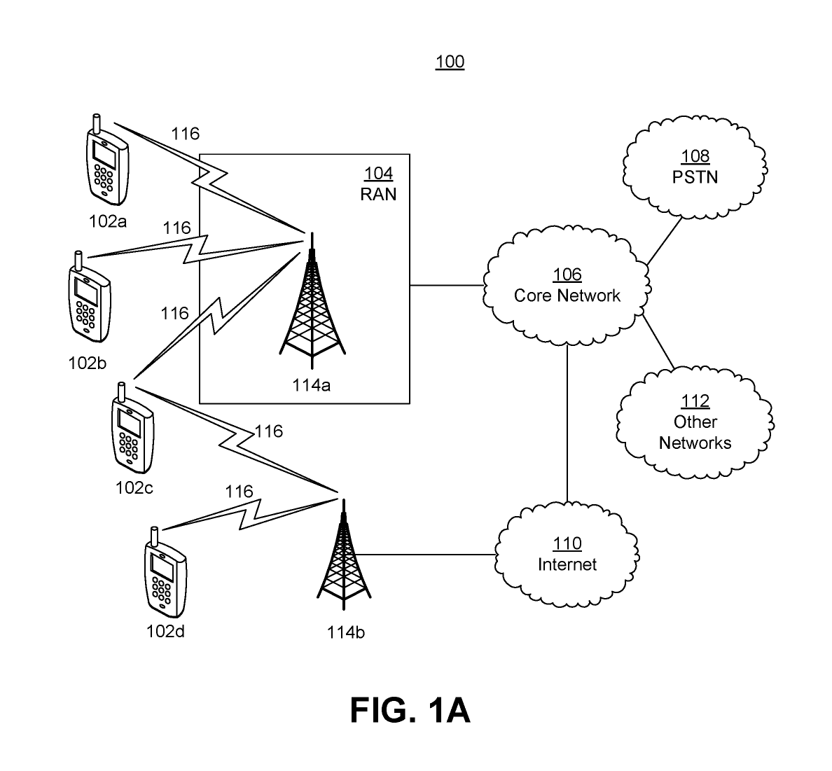

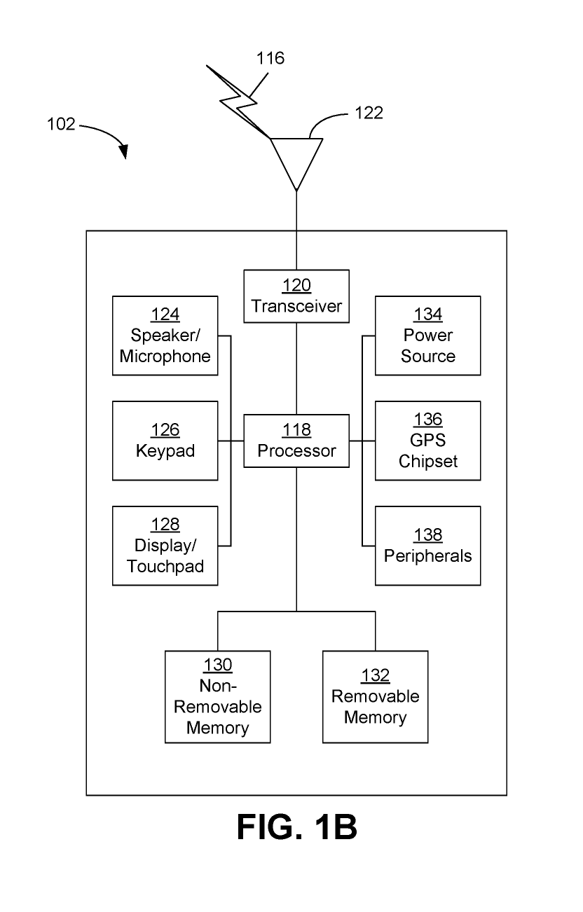

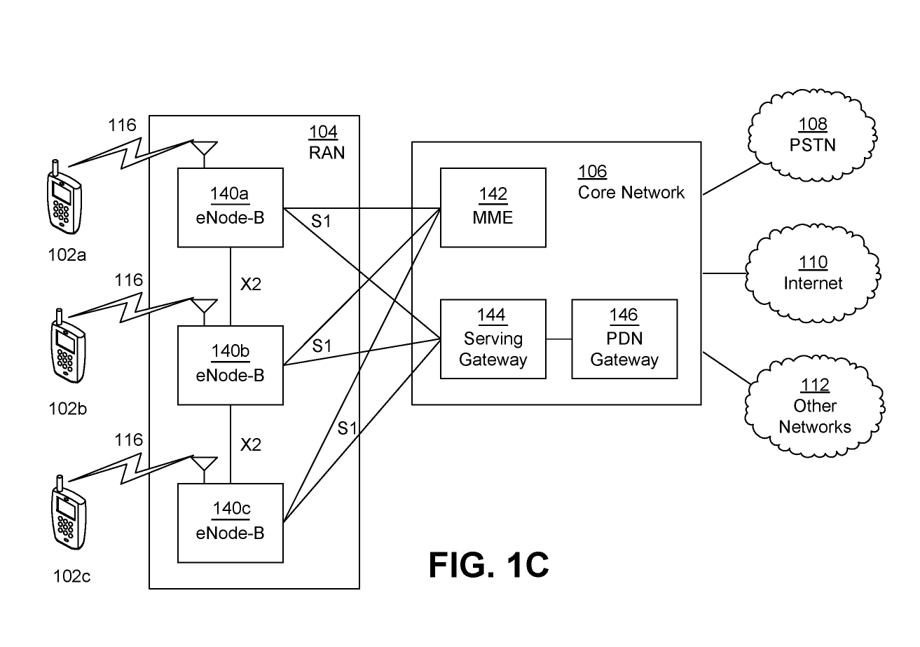

FIG. 1A is a system diagram illustrating a representative communication system 100 in which various embodiments may be implemented.

The communication system 100 may be a multiple access system that may provide content, such as voice, data, video, messaging, and/or broadcast, among others, to multiple wireless users. The communication system 100 may enable multiple wireless users to access such content through the sharing of system resources, including wireless bandwidth. For example, the communication systems 100 may use one or more channel access methods, such as code division multiple access (CDMA), time division multiple access (TDMA), frequency division multiple access (FDMA), orthogonal FDMA (OFDMA), and/or single-carrier FDMA (SCFDMA), among others.

As shown in FIG. 1A, the communication system 100 may include: (1) WTRUs 102a, 102b, 102c and/or 102d; (2) a RAN 104; a CN 106; a public switched telephone network (PSTN) 108; the Internet 110; and/or other networks 112. It is contemplated that the disclosed embodiments may include any number of WTRUs, base stations, networks, and/or network elements. Each of the WTRU s 102a, 102b, 102c, or 102d may be any type of device configured to operate and/or communicate in a wireless environment. By way of example, the WTRUs 102a, 102b, 102c or 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, and/or consumer electronics, among others.

The communication system 100 may also include a base station 114a and a base station 114b. Each of the base stations 114a or 114b may be any type of device configured to wirelessly interface with at least one of the WTRUs 102a, 102b, 102c, and/or 102d to facilitate access to one or more communication networks, such as the CN 106, the Internet 110, and/or the other networks 112. By way of example, the base stations 114a and 114b may be a base transceiver station (BTS), a Node-B, an eNode B, a Home Node B, a Home eNode B, a site controller, an access point (AP), and/or a wireless router, among others. While the base stations 114a, 114b are each depicted as a single element, it is contemplated that the base stations 114a and 114b may include any number of interconnected base stations and/or network elements.

The base station 114a may be part of the RAN 104, which may include other base stations and/or network elements (not shown), such as a base station controller (BSC), a radio network controller (RNC), and/or relay nodes, among others. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three cell sectors. In certain exemplary embodiments, the base station 114a may include three transceivers, i.e., one for each sector of the cell.

In various exemplary embodiments, the base station 114a may employ multiple-input multiple-output (MIMO) technology and may utilize multiple transceivers for each sector of the cell. The base stations 114a and 114b may communicate with one or more of the WTRUs 102a, 102b, 102c and/or 102d over an air interface 116, which may be any suitable wireless communication link (e.g., radio frequency (RF), microwave, infrared (IR), ultraviolet (UV) and/or visible light, among others). The air interface 116 may be established using any suitable radio access technology (RAT). As noted above, the communication system 100 may be a multiple access system and may employ one or more channel access schemes, such as CDMA, TDMA, FDMA, OFDMA, and/or SC-FDMA, among others. For example, the base station 114a in the RAN 104 and the WTRUs 102a, 102b, and 102c may implement a RAT such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In certain exemplary embodiments, the base station 114a and the WTRUs 102a, 102b and 102c may implement a RAT such as Evolved UMTS Terrestrial Radio Access (E-UTRA), which may establish the air interface 116 using Long Term Evolution (LTE) and/or LTE-Advanced (LTE-A).

In certain exemplary embodiments, the base station 114a and the WTRUs 102a, 102b and 102c may implement RAT such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), and/or GSM EDGE (GERAN), among others.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, and/or a campus, among others. In certain exemplary embodiments, the base station 114b and the WTRUs 102c and 102d may implement a RAT such as IEEE 802.11 to establish a wireless local area network (WLAN). In certain exemplary embodiments, the base station 114b and the WTRUs 102c and 102d may implement a RAT such as IEEE 802.15 to establish a wireless personal area network (WPAN). In certain exemplary embodiments, the base station 114b and the WTRUs 102c and 102d may utilize a cellular based RAT (e.g., WCDMA, CDMA2000, GSM, LTE, LTE-A, etc.) to establish a picocell or femtocell. As shown in FIG. 1A, the base station 114b may have a direct connection to the Internet 110. The base station 114b may access the Internet 110 via the CN 106 or may access the Internet directly or through a different access network.

The RAN 104 may be in communication with the CN 106, which may be any type of network configured to provide voice, data, applications, and/or voice over internet protocol (VoIP) services to one or more of the WTRUs 102a, 102b, 102c, and/or 102d. For example, the CN 106 may provide call control, billing services, mobile location-based services, pre-paid calling, internet connectivity, video distribution, and/or perform high-level security functions, such as user authentication, among others. Although not shown in FIG. 1A, it is contemplated that the RAN 104 and/or the CN 106 may be in direct or indirect communication with other RANs that employ the same RAT as the RAN 104 or a different RAT. For example, in addition to being connected to the RAN 104, which may be utilizing an E-UTRA radio technology, the CN 106 may also be in communication with another RAN employing a GSM radio technology.

The CN 106 may also serve as a gateway for the WTRUs 102a, 102b, 102c, and 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The other networks 112 may include wired or wireless communication networks owned and/or operated by other service providers. For example, the other networks 112 may include another CN connected to one or more RANs, which may employ the same RAT as the RAN 104 or a different RAT.

Some or all of the WTRUs 102a, 102b, 102c and 102d in the communication system 100 may include multi-mode capabilities (e.g., the WTRUs 102a, 102b, 102c, and/or 102d may include multiple transceivers for communicating with different wireless networks over different wireless links). For example, the WTRU 102c may be configured to communicate with the base station 114a, which may employ a cellular-based RAT, and with the base station 114b, which may employ an IEEE 802 RAT. FIG. 1B is a system diagram illustrating a representative WTRU that may be used within the communication system illustrated in FIG. 1A.

As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and/or other peripherals 138, among others. It is contemplated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), and/or a state machine, among others. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. Although FIG. 1B depicts the processor 118 and the transceiver 120 as separate components, it is contemplated that the processor 118 and the transceiver 120 may be integrated together in an electronic package or chip. The transmit/receive element 122 may be configured to transmit signals to, or receive signals from, a base station (e.g., the base station 114a) over the air interface 116. For example, in certain exemplary embodiments, the transmit/receive element 122 may be an antenna configured to transmit and/or receive radio frequency (RF) signals. In various exemplary embodiments, the transmit/receive element 122 may be an emitter/detector configured to transmit and/or receive infrared (IR), ultraviolet (UV), and/or visible light signals, for example. In some exemplary embodiments, the transmit/receive element 122 may be configured to transmit and receive both RF and light signals. It is contemplated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122 and/or may employ MIMO technology. In certain exemplary embodiments, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. The transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) unit or organic light emitting diode (OLED) display unit). The processor 118 may output user data to the speaker/microphone 124, the keypad 126, and/or the display/touch pad 128. The processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of fixed memory storage device. The removable memory 132 may include a subscriber identity module (SIM) card, a memory stick, and/or a secure digital (SD) memory card, among others. In certain exemplary embodiments, the processor 118 may access information from, and store data in, memory that is not physically located at and/or on the WTRU 102, such as on a server or a home computer (not shown).

The processor 118 may be configured to receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), and/or lithium ion (Li-ion), among others), solar cells, and/or fuel cells, among others.

The processor 118 may be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a and/or 114b) and/or may determine its location based on the timing of the signals being received from two or more nearby base stations. It is contemplated that the WTRU 102 may acquire location information by way of any suitable location-determination method.

The processor 118 may further be coupled to other peripherals 138, which may include one or more software and/or hardware modules that provide additional features, functionality, and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, and/or an Internet browser, among others. FIG. 1C is a system diagram illustrating a representative RAN 104 and a representative CN 106 according to certain representative embodiments. The RAN 104 may employ the E-UTRA radio technology to communicate with the WTRU s 102a, 102b, and 102c over the air interface 116. The RAN 104 may be in communication with the CN 106.

Although the RAN 104 is shown to include eNode Bs 140a, 140b, and 140c, it is contemplated that the RAN 104 may include any number of eNode Bs. The eNode Bs 140a, 140b, and 140c may each include one or more transceivers for communicating with the WTRUs 102a, 102b, and 102c over the air interface 116. The eNode B 140a, for example, may use MIMO technology or may use multiple antennas to transmit wireless signals to, and receive wireless signals from, the WTRU 102a.

Each of the eNode Bs 140a, 140b, and/or 140c may be associated with a particular cell (not shown) and may be configured to handle radio resource management decisions, handover decisions, and/or scheduling of users in the UL and/or downlink (DL), among others. As shown in FIG. 1C, the eNode Bs 140a, 140b, and 140c may communicate with one another over an X2 interface.

The CN 106 may include a mobility management gateway (MME) 142, a SeGW 144, and a packet data network (PDN) gateway 146. Although each of the foregoing elements is depicted as part of the CN 106, it is contemplated that anyone of these elements may be owned and/or operated by an entity other than the CN operator.

The MME 142 may be connected to each of the eNode Bs 142a, 142b, and/or 142c in the RAN 104 via an S1 interface and may serve as a control node. For example, the MME 142 may be responsible for: (1) authenticating users of the WTRUs 102a, 102b, and 102c; (2) bearer activation/deactivation; and/or (3) selecting a particular SeGW during an initial attach (e.g., attachment procedure) of the WTRUs 102a, 102b, and 102c, among others. The MME 142 may provide a control plane function for switching between the RAN 104 and other RANs that employ other RAT, such as GSM or WCDMA.

The serving gateway (SeGW) 144 may be connected to each of the eNode Bs 140a, 140b, and 140c in the RAN 104 via the S1 interface. The SeGW 144 may generally route and forward user data packets to/from the WTRUs 102a, 102b and 102c. The SeGW 144 may perform other functions, such as anchoring user planes during inter-eNode B handovers, triggering paging when DL data is available for the WTRUs 102a, 102b, and 102c, and/or managing and storing contexts of the WTRUs 102a, 102b and 102c, among others.

The SeGW 144 may be connected to the PDN gateway 146, which may provide the WTRU s 102a, 102b, and 102c with access to packet-switched networks, such as the Internet 110, to facilitate communications between the WTRUs 102a, 102b and 102c and IP-enabled devices.

The CN 106 may facilitate communications with other networks. For example, the CN 106 may provide the WTRUs 102a, 102b and 102c with access to circuit-switched networks, such as the PSTN 108, to facilitate communications between the WTRUs 102a, 102b and 102c and traditional land-line communication devices. For example, the CN 106 may include, or may communicate with, an IP gateway (e.g., an IP multimedia subsystem (IMS) server) that may serve as an interface between the CN 106 and the PSTN 108. The CN 106 may provide the WTRUs 102a, 102b, and 102c with access to the other networks 112, which may include other wired or wireless networks that are owned and/or operated by other service providers.

An ICN network may decouple content from hosts at the network level and retrieve a content object by its name (e.g., an identifier), instead of its storage location (e.g., host IP address), in order to address an IP network's limitations in supporting content distribution. ICN systems may face scalability and efficiency challenges in global deployments.

The number of content objects may be large, and may be rapidly growing. These objects may be stored at any location in the Internet, and may be created, replicated and deleted in a dynamic manner.

Content advertisement may be different from IP routing in that the number of content objects may be much larger. Content advertisement may use different operations to cope with scalability.

The scalability and efficiency of ICNs may be affected by naming, name aggregation, and routing and name resolution schemes. The names of content objects may be aggregated in publishing content locations, and content routing and name resolution may be optimized.

The mechanisms for content naming, routing and name resolution may vary depending upon the ICN architecture. In some ICN networks, flat self-certifying names may be employed, whereas in others, a hierarchical naming scheme with binary-encoded uniform resource locators (URLs) may be used.

In content publishing, content availability may be announced to other content routers (CRs) via a traditional flooding protocol or a distributed hash table (DHT) scheme, among others. To retrieve a content object, a request may be forwarded to the best content source or sources in the network employing either a direct name-based routing on the requested object identifier (ID) or a name resolution process that resolves an ID into a network location (e.g., an IP address or a more general directive for forwarding).

In certain representative embodiments, procedures, methods and/or architectures for matching publishers and subscribers of information in an ICN system may be implemented.

In certain representative embodiments, the matching operation may include matching based on any of: (1) locations of the publishers and/or subscribers; (2) a form of publisher identity information; (3) privacy requirements; (4) a price constraint (e.g., a per item constraint); and/or (5) a Quality of Experience (QoE) for the item.

In certain representative embodiments, the matching operation may occur, for example, in the L3 layer and/or the application layer.

In certain representative embodiments, information may be routed rather than bit packets being sent from endpoint A to endpoint B. An operation for routing information within ICN networks or using ICN networks may include a rendezvous, which may match the publishers of information and the subscribers to the information into a temporal relationship (e.g., a temporal communication relationship). The relationship, which may be created on-the-fly (e.g., dynamically) may enable forwarding of the particular information from the chosen publisher or publishers to the subscriber or subscribers. In certain scenarios, the rendezvous operation may perform (e.g., generally perform) a non-discriminative match (e.g., a single publisher may be selected from a set of matching publishers offering the information and all subscribers (who have currently subscribed to the information) may be chosen for the match). In the case of several potential publishers, one publisher may be chosen (e.g., randomly chosen) in the matching operation. In one example, the procedure may be performed offline and may lead to the population of Forwarding Information Bases (FIB) routing tables in an intermediary forwarding elements. In another example, a centralized rendezvous function or unit may perform the matching operation with received publications and/or subscriptions (e.g., every one or a portion of the received publications and/or subscriptions).

In certain examples, real-time FIBs and the determination of a forwarding path to subscribers may be eliminated by relying on, for example, “scope trees.” In other examples, a per-scope centralized entity referred to as a “scope root” may match each content request with the location (e.g., ultimate location) of the content, for example, on condition that several potential locations exist.

Non-discriminative matching may be implemented through basic operations of an ICN. For example, publishers and subscribers may be brought together or matched solely based on information offered by the publishers and/or subscribers. By including discriminative matching operations, selection of publishers and subscribers may be based on a clearly formulated discriminative factor (e.g., one or more matching constraints). The matching constraint may itself be dependent on publisher and/or subscriber information and/or constraints relating to the information itself.

In certain representative embodiments, methods, apparatus and systems are implemented for Information Centric Networks (ICNs). For example, a system architecture and its interfaces, a hierarchical namespace corresponding to surrogate server management, and/or load balancing procedures in conjunction with the architecture and namespace for the ICN framework are disclosed herein.

In certain representative embodiments, methods, apparatus and systems are implemented to enable surrogate server operations to provide, for example, server mirroring and switchover (e.g., fast switchover) operations in ICNs.

Certain representative embodiments may include:

(1) an ICN system architecture, for example, (i) with a Resilience Manager (RM) node that may be responsible for coordinating and/or managing and/or may itself coordinate and/or manage one or more surrogate servers throughout the network (e.g., the ICN); (ii) one or more interfaces between a Network Attachment Point (NAP) and a Virtual Machine Manager (VMM) for a virtual machine (VM) (e.g., to execute instructions received from the RM); and/or (iii) one or more interfaces between a Topology Manager (TM) and the RM (e.g., to receive network-wide and server state information at the RM);

(2) a Namespace with corresponding scope and hierarchy structure, for example, configured to enable: (i) server and network level statistics to be communicated to and/or with the RM, and (ii) on-demand and/or dynamic surrogate server management with execution information conveyed from the RM to the local NAPs/sNAPs.

(3) one or more load balancing procedures for the ICN and its entities, for example: (i) with the RM receiving areal/regional traffic statistics and/or local traffic statistics from the NAPs/sNAPs (for example, the RM may receive statistics including load level (e.g., load level information)), average, minimum and/or maximum Round Trip Time (RTT) among others, and/or content information, (ii) with the overall information available, the RM may perform surrogate management decision-making (for example, including surrogate spin-up, surrogate spin-off, and/or load throttling), and/or (iii) with the RM conveying the corresponding execution commands to the NAPs/sNAPs and/or the VMMs thereafter in accordance with the appropriate namespace.

Methods, apparatus and/or procedures may be implemented for the ICN in which content may be exchanged via information addressing, while connecting appropriate networked entities that are suitable to act as a source of information towards the networked entity that requested the content.

In certain representative embodiments, architectures for the ICN may be implemented, for example as overlays over existing, e.g., IP- or local Ethernet-based, architectures, enabling realization of the desired network level functions, methods and/or procedures via partial replacement of current network infrastructure. A migration to the desired network level functions, methods and/or procedures may require a transition of WTRUs and/or user equipment (UEs) to an ICN-based solution. With IP-based applications providing a broad range of Internet services in use nowadays, transitioning all or substantially all of these applications may be a hard task as it may require, for example, a protocol stack implementation and a transition of the server-side components, e.g., e-shopping web-servers, among others. It is contemplated that IP-based services with it purely IP-based UEs, may continue to exist for some time to come.

In certain embodiments, ICN at the network level may be implemented, for example, to increase efficiency (1) by the use of in-network caches, (2) by spatial/temporal decoupling of the sender/receiver in general, and/or (3) by the utilization of Software Defined Network (SDN) upgrades for improved flow management, among others.

Certain methods may be implemented for providing HTTP-level services over an ICN network, for mapping HTTP request and RESPONSE methods into appropriate ICN packets, which may be published towards appropriate ICN names. The mapping may be performed at the NAP/sNAP of the client and the server, respectively (and, for example, one or more ICN border gateways (GWs) for cases involving peering networks (in which HTTP services (e.g., methods) are provided to or come from (e.g., sent towards and/or from) peering networks). Performing such HTTP-over-ICN operations may improve operational performance of the underlying transport network. For example, surrogate servers, e.g., authorized copies of HTTP-level servers—also often called mirror servers may be set up (e.g., placed and/or migrated) throughout the network and their activation/deactivation and management (e.g., ongoing management) controlled.

In certain representative embodiments, with a communication in an HTTP-over-ICN network taking place over HTTP only (e.g., using the fully qualified domain name (FQDN) as well as the URL of the HTTP request), such surrogate servers may be established in many places in the network, and interfaced to the ICN network through the NAP/sNAP. With such capability, such surrogate servers may be dynamically provisioned to the user-facing clients based on (e.g.) server load, network load, delay constraints, and/or locality constraints, among many others.

In certain representative embodiments, a system, apparatus and/or method may be implemented that may provide a framework for surrogate placement, activation and/or management (e.g., that may be utilized by various constraint-based decision algorithms).

### Representative Network System Architecture

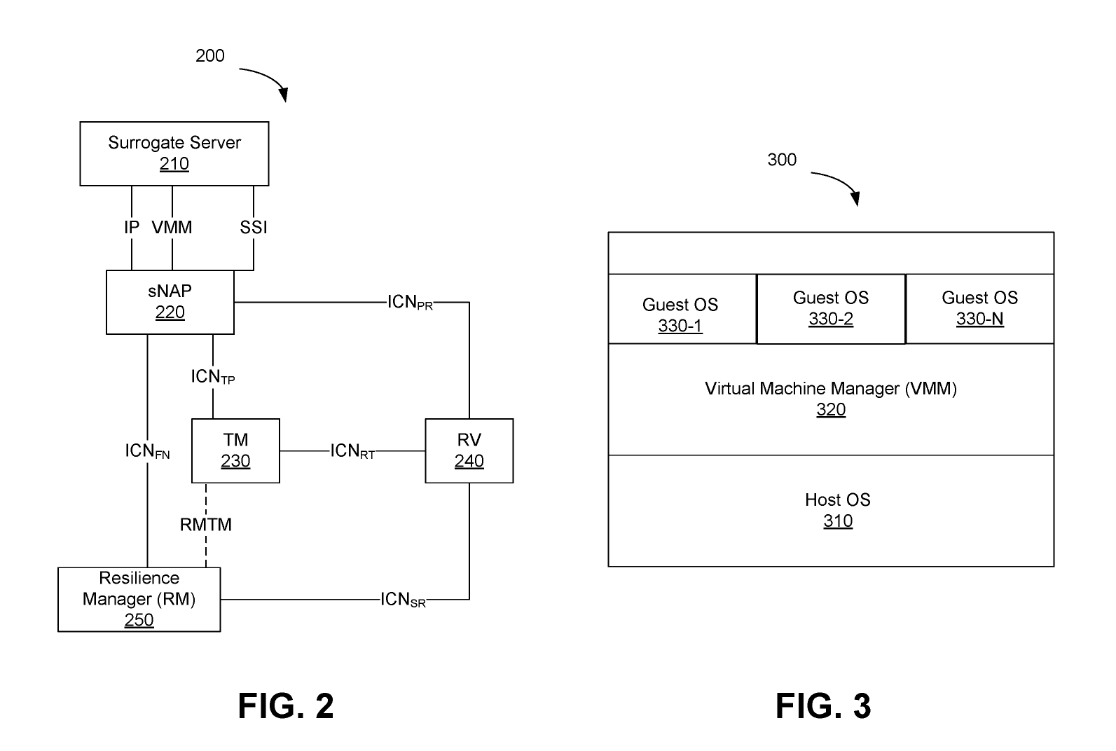

FIG. 2 is a diagram illustrating a representative network system architecture and representative interfaces including a RM function, module, and/or hardware.

Referring to FIG. 2, the representative network system architecture 200 may include one or more surrogate servers (SSs) 210, one of more Surrogate NAPs (sNAPs) 220, one or more TMs 230, one more Rendezvous Nodes (RVs) 240. The SS 210 may have any of: (1) an IP interface, (2) a VMM interface; and/or (3) an SSI interface with the sNAP 220. The sNAP 220 may have any of: (1) the IP interface with the SS 210; (2) the VMM interface with the SS 210; (3) the SSI interface with the SS 210; (4) an ICN_{TP} interface with the TM 230; (5) an ICN_{PR} interface with the RV 240; and/or (6) an ICN_{FN} interface with the RM 250. The TM 230 may have any of: (1) the ICN_{TP} interface with the sNAP 220; (2) an ICN_{RT} interface with the RV 240; and/or (3) an RMTM interface with the RM 250. The RV 240 may have any of: (1) the ICN_{PR} interface with the sNAP 220; (2) the ICN_{RT} interface with the TM 230; and/or (3) an ICN_{SR} interface with the RM 250. The RM 250 may have any of: (1) the ICN_{FN} interface with the sNAP 220; (2) the RMTM interface with the TM 230; and/or (6) an ICN_{SR} interface with the RV 240. In certain representative embodiments, the interfaces may be combined. In certain representative embodiments, the interfaces disclosed herein may be associated with a data plane and/or a control plane. For example, these interfaces may communicate data and/or control signaling/information. In at least one embodiment, the control signaling/information may be provided over different interfaces and/or may be provided over the same interfaces via different routes than the data communications.

In certain representative embodiments, the SS 210 may be a server that has a FQDN associated therewith. One or more VMs 320 may execute on the SS 210. Each VM 320 may have an instance associated with a FQDN. A sNAP 220 may generally refer to a NAP that servers a particular surrogate server.

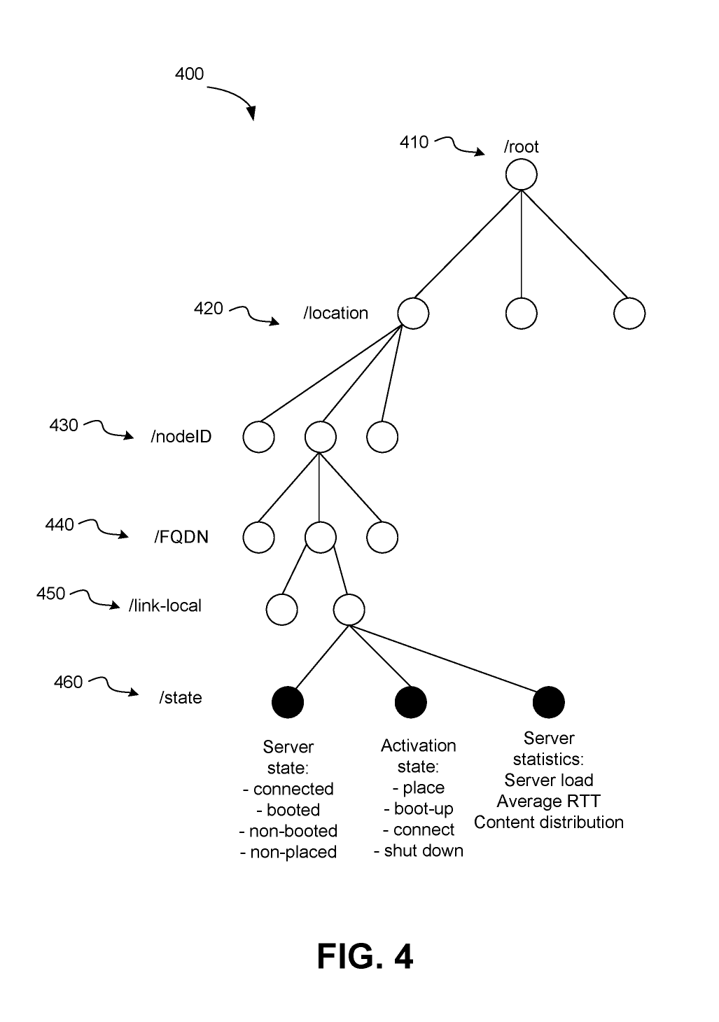

Although FIG. 2 shows a single RM 250 and a single SS 210 for a network, any number of RMs and/or SSs are possible. For example, a plurality of the network nodes may be deployed and may be interfaced in a network deployment. A single sNAP 220 may communicate with (e.g., be communicatively connected to) multiple SSs 210 where different SSs 210 may operate with different operating systems or a respective SS 210 may operate using multiple operating systems, as illustrated in FIG. 3. It is contemplated that the SSs 210 in the representative architecture herein is of a surrogate nature (providing for a mirroring/surrogate function/service (for example, an original server may by default provide its own mirroring surrogate capabilities), e.g., have its own redundant storage and/or be the only surrogate). In addition to or in lieu of the IP interface from the SS 210 to the sNAP 220, the VMM interface may be provided to communicate suitable information on surrogate state (for example, placed, booted, connected, and/or not connected, among others) and/or may be used to control the activation state (for example, place, boot-up, connect, and/or shutdown, among others). The sNAP 220 may publish the surrogate state and/or may react to activation commands according to the namespace 400 provided in FIG. 4, communicating with the VMM subsystem 320 of the SS 210 (see FIG. 3), for example to realize appropriate actions and to retrieve the appropriate information. The SSs 210 may directly or indirectly utilize the SSI interface to the sNAP 220 (e.g., between the SS 210 and the sNAP 220) to provide information on surrogate statistics (see FIG. 4). Detailed information on the VMM and SSI interface is disclosed herein. A dedicated interface (e.g., the RMTM interface) may be utilized between the RM 250 and the TM 230 to provide network resource information from the TM 230 to the RM 250, for example, that supports decision making algorithms. The namespace structure utilized and the usage through the components in the system architecture of FIG. 2 is disclosed herein.

FIG. 3 is a diagram illustrating a representative surrogate node (e.g., the SS) 210.

Referring to FIG. 3, a representative surrogate node 210 (e.g., having a surrogate architecture) may be implemented. The surrogate node (e.g., surrogate architecture) 210 may provide a virtualization platform, on top of a host operating system (OS) 310 such as Windows and/or Linux that may be managed by the VMM 320, which may allow for establishing various Guest OS instances 330-1, 330-2 . . . 330-N according to defined profiles. The defined profiles may be managed by the VMM 320. Examples for VMM platforms may include common hypervisor platforms such as VMWare and/or Zen. In another representative embodiment, the VMM 320 may provide a container environment (such as provided through Dockers), allowing for application-level containerization rather than entire OS-level containers.

### Representative Namespace for Surrogate Control

FIG. 4 is a diagram illustrating a representative namespace, for example used for information exchange.

Referring to FIG. 4, the representative namespace 400 may define a structure of the information being exchanged in the system. The representative namespace may include any of: (1) a first level node 410 (e.g., a root level node); (2) one or more second level nodes 420 (e.g., location nodes); (3) one or more third level nodes 430 (e.g., nodeID nodes); (4) one or more fourth level nodes 440 (e.g., FQDN nodes); (5) one or more fifth level nodes 450 (e.g., link-local nodes); (6) and/or one or more seventh level nodes (e.g., state nodes), among others. The representative namespace 400 may include any number of nodes (including zero nodes) of a level that may be associated with a node of the next higher level. The root node and its associated nodes thereunder are referred to as the scope of the root node. A scope of any node may be based on that particular node.

The information may be exchanged utilizing the same pub/sub delivery system that is also realizing the HTTP and IP message exchange for which the SSs 210 are connected to the network. It is contemplated that in certain representative embodiments a dedicated/root namespace may be utilized. In lieu of a dedicated/root namespace, the namespace may be embedded as a sub-structure under some other well-known namespace. At a first level, a level of grouping under some constraint may be established (for example FIG. 4 illustrates location as a representative first level constraint).

Although the disclosure herein uses/location as the first level constraint, other first level constraints may be possible. For example, other constraints may include population characteristic and/or other contextual information (for example, those of time-dependent surrogates).

It is contemplated that the namespace structure may be established by the TM 230 using one or more established policies (e.g., under some well-known policies such that the policies are known to the elements in the system utilizing the namespace). The/location may be used as a grouping with location, for example, following a city-level grouping.

Under each of the group scopes, the/nodeID may be published. The nodeID may be associated with the node that is currently attached to the network, according to the grouping. These nodeIDs may be for the nodes assigned to the sNAPs 220 (as those network elements (e.g., only those network elements) may be of interest as the SSs 210 may attach (e.g., may only attach) to the appropriate sNAPs 220, for example during the attachment phase (e.g., the connection to the network)). The representative namespace 400 may provide grouping-specific information of what nodeID may be available under a specific grouping criteria (e.g., nodeIDs associated with and/or for London may be grouped separately from nodeIDs associated with and/or for Paris). The nodeID scopes may be created by the TM 230 based on available categorization criteria (such as location). The TM 230 may remove nodeID scopes (and, for example, entire sub-graphs underneath), for example, in cases of sNAP failures. Such failures may be observed with link state protocols and/or SDN methods for link state monitoring.

In certain representative embodiments, under each nodeID scope, the/FQDN (fully qualified domain name) of each locally attached SS 210 may be published by the sNAP 220. This FQDN information may be populated: (1) during a registration phase (e.g., when the SS 210 may send a DNS registration to the network; (2) due to some offline registration procedure, such as via a configuration file at the sNAP 220, which may be invoked when the SS 210 becomes locally available); and/or (3) when the sNAP 220 may be instructed by the RM 250 through an activation state. In addition to publishing the FQDN scope, the sNAP 220 may publish a /link-local address that may be assigned to the FQDN instance (for cases in which more than one instance is instantiated locally). The link-local address may be the link-local IP address (e.g., for cases in which a Network Address Translation (NAT) may be used) and/or the surrogate Ethernet address, among others.

Each such surrogate instance at a particular sNAP 220 may be identified (e.g., clearly identified) through a path/root/location/nodeID/FQDN/link-local in the representative namespace 400. Under each such surrogate scope, there may exist state information (e.g., two pieces of state information), shown as black circles in FIG. 4. The server state may indicate the surrogate state (e.g., the current surrogate state), such as: (1) connected (to the network via the sNAP), booted (ready to be connected), (2) non-booted (the VM at the surrogate exists for this FQDN but has not yet booted up) and/or (3) non-placed (the sNAP 220 has been identified as being a location for the surrogate but the VM image does not yet exist in the SS), among others. The server state information may be populated by the sNAP 220 and may utilize the VMM interface in FIG. 2 between the sNAP 220 and the VMM 320 in the SS 210. In certain representative embodiments, the state information may be encoded using any of: (1) an XML-based encoding, (2) a type-value encoding (which may be more efficient) and/or (3) a bit field option in which the state information is encoded as a single byte indicator and/or a single bit flag. The RM 250 may subscribe to the server state information, for example, to allow for placement and activation decision making for individual surrogates (e.g., SSs 210) at the sNAPs 220 in the system 200.

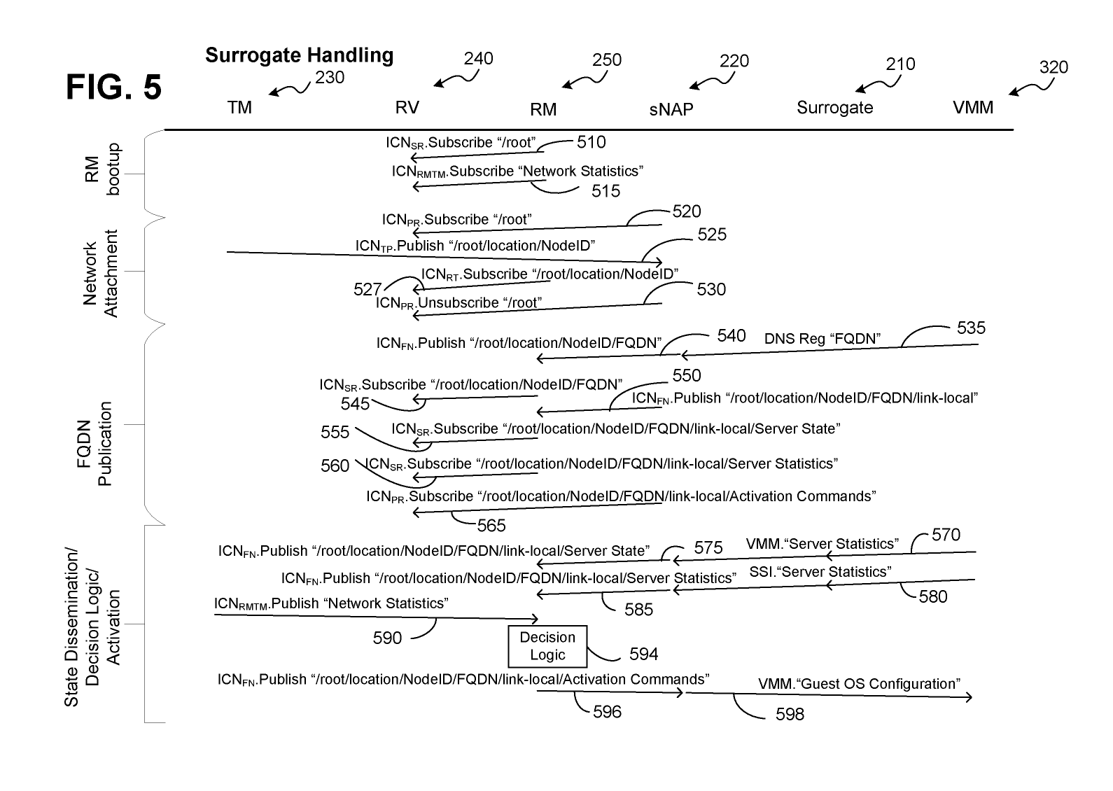

For realizing activation of surrogates (e.g., SSs 210), activation state information, as a second information item under the specific surrogate instance may be implemented, The RM 250 may publish activation commands, such as: (1) place, (2) boot-up, (3) connect and/or (4) shutdown, among others. The activation commands may be issued based on input from the TM 230 via the RMTM interface. The RMTM interface may make available certain information (e.g., link state information, congestion information, and other network information). The information available from the RMTM interface may be provided via any of: (1) ICN infrastructure, as shown in FIG. 5; and/or (2) a Simple Network Management Protocol/Management Information Base (SNMP/MIB) module/function/mechanisms, for example, in case the RM 250 and the TM 230 are implemented in a joint server. In addition to the inputs via the RMTM interface, the activation commands may be based on operable (e.g., operational) SSs 210, which may provide information (e.g., make information available) on server performance and/or server operational statistics (e.g., server load, and/or hit rates, among others). The information associated with the operable SSs 210 may be published in a server statistics information item (see FIG. 4) by the sNAP 220, receiving appropriate information from the corresponding surrogate (e.g. SS 210) via the SSI interface (see FIG. 2).

In certain representative embodiments, the server statistics information items may be encoded using any of: (1) an XML-based encoding, and/or (2) a type-value encoding.

In certain representative embodiments, the activation state information items may be encoded using any of: (1) an XML-based encoding, (2) a type-value encoding, and/or (3) a bit field option in which the state information is encoded as a single byte indicator and/or a single bit flag.

The sNAPs 220 may subscribe to the activation state under the scope hierarchy of /root/location/nodeID/FQDN/link-local for the specific surrogate (e.g., SS 210). In certain representative embodiments, the sNAP 220 may subscribe to the scope hierarchy/root/location/nodeID and may be notified of any change in information under its own nodeID scope. Upon receiving an activation command, the sNAP 220 may utilize the VMM interface to appropriately control the VMM 320 in the surrogate node according to received information.

### Representative VMM Interface

The representative VMM interface may serve, for example, as an activation and/or indication interface that may help populate the/Server_state and/or/Activation_state information in the representative namespace 400. The VMM interface may be realized between the NAP/sNAP and the VMM 320, such that the NAP/sNAP may act upon incoming activation commands, may relay and/or send the incoming commands via the VMM interface towards the VMM 320, and may relay and/or send server state information from the VMM interface to the RM 250 (e.g., while relaying the incoming commands). The information relayed or sent may be published according to the representative namespace 400. It is contemplated that the VMM interface may extend a conventional VMM platform, such as hypervisors or containers, that would allow for an activation through an external API (e.g., the VMM interface) and the reporting of container state through the API (e.g., the VMM interface).

### Representative SSI Interface

The representative SSI interface may be used to convey server state information between the sNAP 220 and the attached servers (e.g., SSs) 210. For example, the surrogates (e.g., SSs) 210 may populate statistics including load, average RTT, content distribution, and/or error rates, among others, in a Management Information Base (MIB) database. The population of the MIB database may follow conventional procedures. The retrieval of the statistics between the sNAP 220 and surrogates (e.g., SSs) 210 can be carried out by the SNMP and may follow conventional procedures. It is contemplated that various type-value pair notations may be implemented for the MIB structure to capture the semantics of load, and/or RTT (e.g., average RTT), among others.

### Representative RMTM Interface

The representative RMTM interface may be used for information exchange between the RM 250 and the TM 230. The information may include any of: regional load statistics and/or content type/distribution, among others. The RMTM interface may be in the form of a dedicated link between the TM 230 and the RM 250, or may be performed within the ICN by carrying out standard ICN pub/sub messages (e.g. the RM 250 may subscribe to the corresponding scopes published by the TM 230). It is understood by one of skill in the art that such pub/sub messaging may necessitate an updated namespace with respect to that of FIG. 4. In the case of a dedicated TM-RM link, the information exchange may be performed via SNMP procedures (e.g., standard SNMP procedures).

### Representative Message Sequence Chart (MSC)

FIG. 5 is a representative MSC illustrating a message sequence of the SS 210 and the RM 250 that interfaces with ICN nodes. For brevity conventional operation associated with a pub/sub system (e.g., a publication and subscription system have been omitted. For example, one of skill in the art understands that the communications between the RV 240 and the publishers (e.g., the TM 230, RM 250; and/or the SS 210, among others) is not shown.

In FIG. 5, the representative MSC 500 illustrates the main phases of the surrogate server and RM interaction with other ICN nodes. The main phases may include any of: (1) an RM bootup phase; (2) a network attachment phase; (3) a FQDN publication phase; and/or (4) a state dissemination logic/activation phase, among others. During the RM bootup phase: (1) at 510, the RM 250 may subscribe to the root (e.g., “/root”) from the RV 240 via the ICN_{SR} interface; and/or (2) at 515, the RM 250 may subscribe to network statistics from the RV 240 via the ICN_{RMTM} interface. During the network attachment phase: (1) at 520, the sNAP 220 may subscribe to the root (e.g., “/root”) from the RV 240 via the ICN_{PR} interface; (2) at 525, the TM 230 may publish the nodeID information (e.g., “/root/location/nodeID”) to the sNAP 220 via the ICN_{TP} interface; (3) at 527, the RM 230 may subscribe to the nodeID information (e.g., “/root/location/nodeID”) from the RV 240 via the ICN_{RT} interface; and/or (4) at 530, the sNAP 220 may unsubscribe to the root (e.g., “/root”) from the RV 240 via the ICN_{PR} interface, among others.

During the FQDN publication phase: (1) at 535, the VMM 320 may perform FQDN registration via a Domain Name System (DNS) registration operation; (2) at 540, the sNAP 220 may publish the FQDN information (e.g., “/root/location/nodeID/FQDN”) to the RM 250 via the ICN_{FN} interface; (3) at 545, the RM 250 may subscribe to the FQDN information from the RV 240 via the ICN_{SR} interface; (4) at 550, the sNAP 220 may publish link-local information (e.g., “/root/location/nodeID/FQDN/link-local”) to the RM 250 via the ICN_{FN} interface; (5) at 550, the RM 250 may subscribe from the RV 240 to server state information (e.g., “/root/location/nodeID/FQDN/link-local/Server State”) via the ICN_{SR} interface; (6) at 555, the RM 250 may subscribe from the RV 240 to server statistics information (e.g., “/root/location/nodeID/FQDN/link-local/Server Statistics”) via the ICN_{SR} interface; (7) at 560, the RM 250 may subscribe from the RV 240 to server statistics information (e.g., “/root/location/nodeID/FQDN/link-local/Server Statistics”) via the ICN_{SR} interface. and/or (8) at 565, the sNAP 220 may subscribe from the RV 240 to activation state information/commands (e.g., “/root/location/nodeID/FQDN/link-local/Activation state”) via the ICN_{PR} interface.

During the State Dissemination/Decision Logic/Activation phase: (1) at 570, the VMM 320 and the sNAP 220 may communicate (e.g., exchange) the server state information via the VMM interface; (2) at 575, the sNAP 220 may publish the results (e.g., the server state information, for example “/root/location/nodeID/FQDN/link-local/server state”) to the RM 250 via the ICN_{FN} interface; (3) at 580, the VMM 320 and the sNAP 220 may communicate (e.g., exchange) the server statistics information and/or measurement signaling via the SSI interface; (4) at 585, the sNAP 220 may publish the results (e.g., the server statistics information and/or the measurement signaling, for example “/root/location/nodeID/FQDN/link-local/server statistics”) to the RM 250 via the ICN_{FN} interface; (5) at 590, the TM 230 may publish network statistics information (e.g., the network statistics such as server load, average RTT and/or content distribution) to the RM 250 via the ICN_{RMTM} interface; (6) at 594, the RM 250, based on or using decision logic and/or rules/policies may determine a set of activation commands/states for one or more servers (e.g., SSs) 210, among others; (7) at 596, the RM 250 may publish activation commands and/or activation states to the sNAP 220 via the ICN_{FN} interface; (8) at 598, the sNAP 220 may communicate (e.g., exchange) the activation commands and/or activation states (e.g., using a Guest OS configuration) with the VMM 320 via the VMM interface.

In certain representative embodiments, initially, in the RM boot-up procedure, the RM 250 may leverage a surrogate namespace by subscribing to the “\root” shown in FIG. 4. The RM 250 may subscribe to a “network statistics” scope via the ICN_{RMTM} interface. The network statistics may be collected by the TM 230 in the network. In the network attachment phase, with the sNAP 220 subscribing to the “\root”, the TM 230 may inform the sNAP 220 regarding its node ID, which may be determined by the TM 230 dynamically (e.g. using the server location information and/or link information, among others). To identify the content at each surrogate (e.g., SS) 210, which may include the same content available at multiple surrogates simultaneously, the VMM 320 may carry (e.g., initially may carry) out a standard FQDN registration phase and/or the sNAP 220 may publish this information to the RM 250. To identify the local surrogate ID and the content available to the local surrogate (e.g., local SS) for the FQDN instantiation (e.g., each FQDN instantiation), the sNAP 220 may publish “*/FQDN/link-local” information to the RM. The RM 250 may subscribe to the “*/Server State” information and/or the “*/Server Statistics” information, which may be used in surrogate placing and/or optimization procedures (e.g., in the Decision Logic block 594). The sNAP 220 may subscribe to the commands which may be the output of the optimization procedures and may execute these commands accordingly.

In the state dissemination, decision logic and activation phase, the VMM 320 and the sNAP 220 may interact, for example, by exchanging the server statistics and/or measurement signaling. The sNAP 220 may publish the results to the RM 250 which may utilize the results in the Decision Logic block 594 alone and/or along with the network statistics received from the TM 230. The outcome and/or output of the Decision Logic block 594 may be conveyed to the sNAP 220 via Activation Commands which may send the configuration information to the VMM 320.

### Representative RM Algorithms for Surrogate Selection and Configuration

The RM 250 may enable dynamic allocation and execution of the SSs 210 to further optimize the network operations and traffic management. This dynamic allocation and execution may be based on various statistics collected from any of: (1) the surrogate servers (SSs) 210, (2) the sNAPs 220, (3) a Rendezvous Node (RV) 240, and/or (4) the TM 230, among others based on matching and forwarding parameters (e.g., existing, predetermined and/or dynamically determined matching and/or forwarding parameters).

In certain representative embodiments, load balancing based surrogate management procedures may be implemented, for example, in which the surrogate operations and configurations are dynamically optimized via any of: (1) the sNAP 220, and/or (2) the RM 250, among others. Other variations of surrogate management procedures with different objectives, e.g. latency minimization, are also possible. A number of active surrogate management procedures: (1) executed (e.g., done) locally at the sNAPs 220, (2) executed at the corresponding SSs 210 and/or (3) executed under the control of the RM 250 may be implemented.

Representative Local Load Balancing at the sNAP and SSs

A local load balancing procedure may optimize load within a NAP/sNAP and the associated servers and may be applied in various systems. The local load balancing procedure may be implemented for an ICN system and may be compatible with the ICN framework.

For example, the sNAP 220 may be responsible for load-balancing procedures by screening the loads assigned to or executed at one or multiple SSs 210 associated with the sNAP 220. The sNAP 220 may not utilize the inputs and/or execution commands from the RM 250 for the load balancing procedures (e.g., load balancing purposes), which may result in lower signaling overhead in the network, and potential bandwidth limitation in the area served by the sNAP 220 due to local and/or regional congestion. The local-load balancing may include the following:

(1) SS load screening at the sNAP 220 in which the sNAP 220 may exploit the traffic and load information that it serves to its clients (e.g., end users attached to the sNAP 220) which may be originated and/or obtained from the associated SSs 210. The active screening may help the sNAP 220 to identify: (1) the load information at these SSs 210; and/or (2) latency associated with particular flow/traffic class. The statistics to be extracted from the traffic information regarding the SSs 210 may include error performance (e.g., packet error rate), among others. In certain representative embodiments, the sNAP 220 may request the server statistics using the SSI interface, for example, in the form of an immediate request with a particular information granularity (e.g., load and/or latency information in the last X time window, and/or a periodic request in which the SS 210 feeds back the statistics to the sNAP 220 at a requested time and/or with a predefined periodicity).

(2) new SS spin up procedures such that with the traffic/load statistics information available, the sNAP 220 may identify the use for (e.g., need for) and number of SSs 210 and/or instantiations. Based on this identified information, the sNAP 220, using the VMM interface, may inform the VMM 320 regarding additional server and/or capacity spinning up executions. The VMM 320 may inform the sNAP 220, for example after successfully spinning up, of the requested resources, or may inform the sNAP 220 regarding any insufficient capacity (for example that the Host machine may be or is memory stringent (e.g., already memory stringent). Based on this information, the sNAP 220 may include the newly spun up servers into its server list and/or may contact another host machine for a similar operation. In certain representative embodiments, the number of SSs 210, their functionalities and/or their configurations may be managed by the VMM 320 and/or the sNAP 220. During the spin up procedure of the SSs 210, the VMM 320 may convey a configuration set of the new SSs 210 to the sNAP 220, which may be carried out via the VMM interface.

### The RM Managed Load Balancing Procedures

The load balancing procedures disclosed above include procedures for local load balancing at the sNAP 220 and its corresponding SSs 210. For example, such procedures may enable local distribution and/or balancing of traffic (e.g., to lower congestion and/or overload at particular S Ss 210). In certain instances, spinning up servers over a limit may potentially create bandwidth problems in a vicinity of the sNAP 220. In certain representative embodiments, a RM implementation (for example a RM based and/or centered solution as herein disclosed) may enable load balancing across the sNAPs 220 in a region where the load balancing methods may be implemented based on, for example, the representative namespace 400 of FIG. 4 and/or the representative message sequence chart 500 of FIG. 5.

As one example, the RM 250 may manage spin up of additional SSs 210 in the network. The decision making, carried out by the decision logic as depicted in FIG. 5, may be executed using the following inputs:

(1) Server State Information such that the RM 250 may incorporate server state information in its decision making. The server state information may be obtained from the sNAP 220 by the RM 250 subscribing to the corresponding scopes (“*/server state”) as shown in FIG. 5. In certain representative embodiments, the RM 250 may receive the server statistics and/or states periodically and/or aperiodically based on a trigger condition from the sNAPs 220. In other representative embodiments, the RM 250 may demand these inputs from the sNAP 220 on a need basis and/or based on dynamic or predetermined rules, which may trigger a measurement and/or measurement campaign and/or information exchange between the sNAP 220 and one or more SSs 210 via the SSI interface as described herein.

(2) Network State Information such that the RM 250 may utilize the network state information in managing and/or spinning up SSs 210. The network state information may include any of the following information: (i) bandwidth (BW) utilization/load within an area, (ii) congestion information within an area, (iii) latency within an area. As shown in MSC (in FIG. 5), the RM 250 may obtain this information set from the TM 230.

Representative Load balancing within a sNAP Set

In one representative embodiment, the RM 250 may wish and/or determine to perform load balancing by having server statistics, server status information and/or network level information corresponding to a set of sNAPs 220. For example, by collecting such information the RM 250 may perform a more efficient load-balancing procedure, because the RM 250 may have a better visibility of the network, the corresponding sNAPs 220 and the SSs 210 of those corresponding sNAPs 220. A corresponding procedure may include any of the following:

(1) In one example, the RM 250 may receive a Node ID set in a given region from the TM 230 using the ICN_{RMTM} interface. Based on an inquiry from the RM 250, the TM 230 may forward the Node ID set for the geographical region/location.

(2) After receiving the Node ID set, the RM 250 may individually subscribe to the server load information at the sNAPs 220 (e.g., one, some or each of the sNAPs 220), as shown in FIG. 5, through the */server_statistics sub-space under the individual Node ID and the available FQDNs at this sNAP 220. For example, the receiving sNAP 220 may utilize the server statistics available to itself and obtained through measurement and/or screening procedures on the traffic forwarded and received previously. The sNAP 220 may initiate a measurement and/or a measurement campaign with its surrogate (e.g., SS 210) through the VMM interface. The server statistics may include any of: the parameters of server load, RTT (e.g., maximum, minimum and/or average RTT, and/or content availability/distribution, among others). The measurement and/or measurement campaign between the sNAP 220 and the one or more SSs 210 may be terminated after (e.g., once) the sNAP 220 collects sufficient statistics (e.g., exceeding or above a threshold amount). The level of statistics, e.g. time granularity, and/or size, among others may be conveyed with a request received from the RM 250 and may be part of the */Server_statistics commands scope.

(3) The sNAPs 220 that are in the measurement campaign server set may send the measurement results to the RM 250, which may be performed by: (i) the RM 250 subscribing to the “server statistics” as shown in FIG. 5 (e.g., corresponding to the Node ID set) and (ii) the sNAPs 220 publishing the results in the sub-space (e.g., corresponding to their Node ID and the FQDN of the surrogate (e.g., SS 210)).

(4) With the server statistics corresponding to the measurement set available, in one example, the RM 250 may categorize and/or order the servers (e.g., SSs 210) from most to least or vice versa in the set according to the received statistics based on any of: (1) a server load category; (2) a RTT category (e.g., average RTT category); and/or (3) content category, among others.

The RM 250, based on the categorization process/procedure and/or methodology, may perform load balancing by executing any of the following separately or in combination:

(1) In one example, depending on the server load category, the RM 250 may spin up surrogates (e.g., SSs 210) within the vicinity of heavily loaded surrogates (e.g., SSs 210) (e.g., where their load exceed a threshold). This may include initializing and/or running a VM at these surrogates (e.g., SSs 210). A surrogate spinning up procedure may include any of the following:
(i) a new surrogate spinning up in which the RM 250, utilizing one or both of the local information from the sNAP 220 and/or network-wide/areal state information and/or statistics, may determine (e.g., decide) and/or execute: (a) spin up of one or more servers (e.g., SSs 210) locally at the surrogate (e.g., via a RM 250 triggered local surrogate spin up procedure); (b) spin up servers (e.g., the SSs 210) at different locations in case the sNAP 220 of interest is overloaded and/or the RM 250 has the network state information from the TM 230 that the corresponding network segment is congested. In certain representative embodiments, the RM 250 may initiate surrogate spin up procedures with a different sNAP 220. In one example, the RM 250 may select or may try to select one or more sNAPs 220 that are topologically close to an incumbent sNAP 220. In certain representative embodiments, the RM 250 may publish, for example: (a) the number of servers (e.g., SSs 210), (b) their initial configuration set, e.g. memory capacity, in the */Activation commands instruction under the corresponding Node ID and FQDN sub-structure of the representative namespace 400 that may be determined by the RM 250 to perform these commands (e.g., the activation commands). The sNAPs 220, utilizing the subscription to the */Activation commands, may obtain the surrogate activation and initial configuration instructions and/or implicit information to which FQDN the activation commands apply. Upon receiving this information, the sNAP 220 may instruct the VMM 320 via the VMM interface and may convey the corresponding instructions. The VMM 320 may execute server spin up procedures based on the received instructions.
(I) to further optimize the SSs 210 to be spun up (e.g., the number and/or the location of the SSs 210 to be spun up), the RM 250 may determine and/or consider the content distribution information of the load which it may obtain from its subscription to “*/server statistics” as shown in FIGS. 4 and 5. For instance, the content distribution information may include the type of video requested from particular parts of the network (e.g., from the SSs 210 and forwarded to users populated within a particular region). Obtaining the traffic pattern information corresponding to the particular content via server statistics scope in FIG. 5, the RM 250 may proceed with (e.g., initiate) spinning up the SSs 210 that are closer (e.g., geographically and/or logically closer) to the requestor group of that particular content (e.g., video subscribers) based on the content type.
(II) In case none of the SSs 210 within this vicinity or a small number of the SSs 210 have the content available, the RM 250 may initiate both a surrogate spin up procedure/process and a mirroring procedure/process (e.g., copying the requested content into the selected surrogates (e.g., the SSs 210) to enable mirroring procedures/processes)). For the mirroring process, the RM 250 may contact the TM 230 to request a relevant path between the corresponding sNAPs 220 for transferring the content (to be mirrored from one SS 210 to another SS 210 (e.g., acting as a mirror server)).
(III) Incumbent surrogate deactivation\load limitation procedures/processes may be implemented. In another example, a hybrid process may be implemented which may be different from either the local load balancing procedures or the RM 250 centered procedures disclosed herein. For example, the RM 250 may send a flag and/or overload information to the sNAP 220 when the RM 250 identifies (and/or determines that) a bandwidth problem in the areal vicinity of the sNAP 220. The flag and/or overload information may be conveyed to the sNAP 220 via the *\Activation Commands which the sNAP 220 already subscribed to. Upon receiving the flag/overload information, the sNAP 220 may limit the effective loads/traffic due to associated SSs, which may be accomplished via communications to (e.g., by informing) the VMM 320. The VMM 320 may accordingly limit the SS load capacity and may spin off a number of SSs depending on the received flag/overload information. It is contemplated that the signaling periodicity of the flag/overload information may be constrained to the case (e.g., only constrained to the case) where it occurs, which may result in low (e.g., potentially low) signaling overhead.

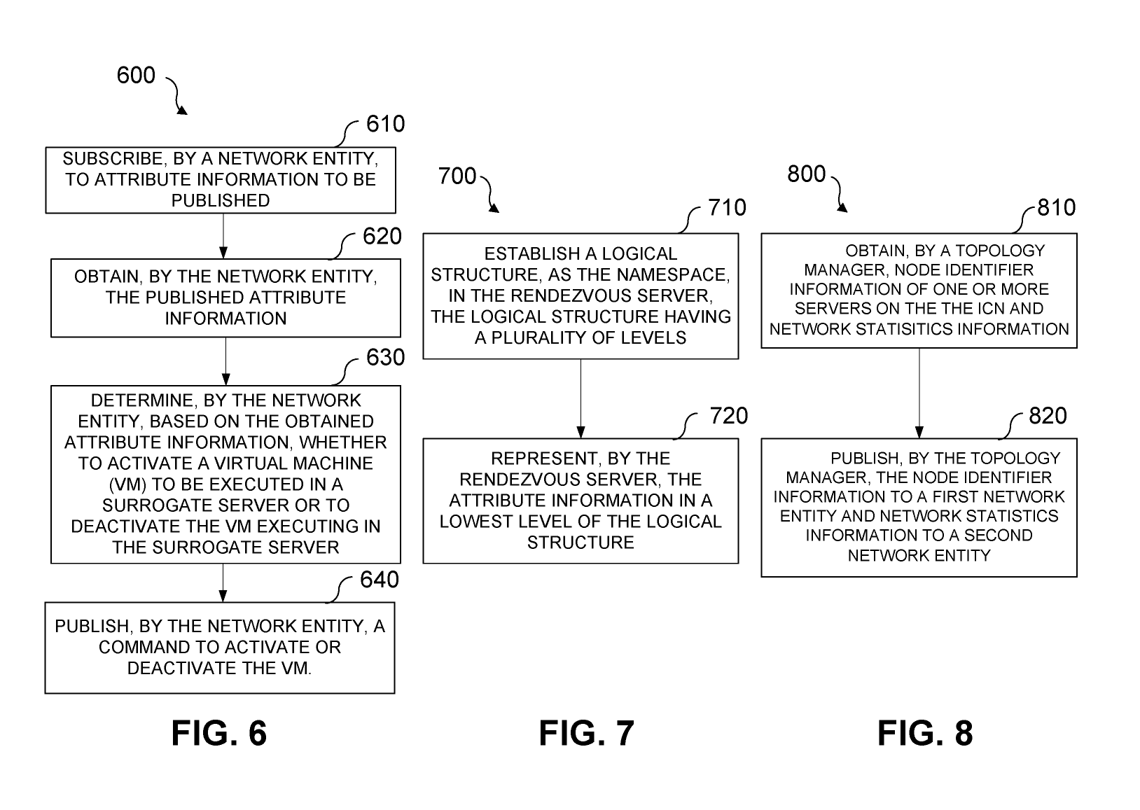

FIG. 6 is a flowchart illustrating a representative method of SS management in an ICN network.

Referring to FIG. 6, the representative method may include, at block 610, a network entity (NE) (e.g., a RM 250) which may subscribe to attribute information to be published. At block 620, the NE 250 may obtain the published attribute information. At block 630, the NE 250 may determine, based on the obtained attribute information, whether to activate a virtual machine (VM) to be executed in a SS 210 or to deactivate the VM executing in the SS 210. At block 640, the NE 250 may send to the SS 210, a command to activate or deactivate the VM.

In certain representative embodiments, the NE (e.g., the RM 250) may subscribe to attribute information from a RV 240. For example, the NE 250 may subscribe to a subscope of the representative namespace 400 including any one or more of: (1) server state information; (2) server statistics information; and/or (3) network statistics.

In certain representative embodiments, the NE (e.g., the RM 250) may obtain any one or more of: (1) server state information via one or more servers and/or virtual machines (VMs); (2) server statistics information from one or more servers and/or VMs; or (3) network statistics via the TM 230.

In certain representative embodiments, the NE (e.g., the RM 250) may determine whether to: (1) activate the VM of the SS 210 to enable any of: (i) server mirroring by the SS 210 of a second SS 210 and/or (i) load balancing between two or more SSs 210, and/or (2) deactivate the VM of the SS 210 to disable any of: (i) the server mirroring by the SS 210 of the second SS 210 and/or (ii) load balancing between the two or more SSs 210.

In certain representative embodiments, the NE (e.g., the RM 250) may compare one or more network or server statistics to one or more thresholds and one or more server states to reference server states, as a set of comparison results; and may determine whether to activate the VM or whether to deactivate the VM, in accordance with the comparison results and one or more policies associated with the comparison results.

In certain representative embodiments, the published attribute information may be represented by and/or stored in one or more attribute information subscope in a namespace (e.g., representative namespace 400) accessible to the NE 250. For example, a subscope of the namespace (e.g., representative namespace 400) may include location information at a first layer (e.g., a first level), one or more node IDs in a second, lower layer (e.g., a lower level) and one or more attribute information subscope in a layer (e.g., level) lower than the second, lower level.

In certain representative embodiments, the NE 250 may determine whether the SS 210 is overloaded and/or whether a network segment in a vicinity of the SS 210 is congested based on the attribute information; and may send commands to spin up one or more other SSs 210 at different locations in the ICN under the condition that the SS 210 is overloaded and/or the network segment in the vicinity of the SS 210 is congested.

In certain representative embodiments, the NE (e.g., the RM 250) may determine congestion by any of: (1) load information at SSs 210 served by a sNAP (e.g., another NE) 220; (2) latency of particular flows associated with the SSs 210 served by the sNAP 220; and/or (3) error performance information associated with the SSs 210 served by the sNAP 220.

In certain representative embodiments, the NE (e.g., the RM 250) may determine whether the network segment in the vicinity of or in a location at the SS 210 and/or sNAP 220 is locally congested.

In certain representative embodiments, the NE 250 may send a command to a second NE (e.g., the SS 210) to activate one or more other VMs associated with the second NE 210 on the condition that the vicinity of the second NE 210 or a location at the second NE 210 is regionally congested such that load balancing is enabled between or among SSs 210 associated with the second NE 210.

In certain representative embodiments, the NE 250 may determine whether a network segment in a region proximate to the vicinity of or in a location at the second NE 210 is regionally congested.

In certain representative embodiments, the NE 250 may send a further command to another NE (e.g., the SS 210) to activate other VMs associated with the other NE on the condition that the region proximate to the vicinity of or in a location at the second NE 210 is regionally congested such that load balancing is enabled between or among SSs 210 associated with different NEs (e.g., the RM 250, the TM 230 and/or the sNAP 220, among others).

In certain representative embodiments, the NE 250 may obtain content distribution information of a network segment associated with the second NE (e.g., the SS 210), may determine one or more locations for storage of a particular content based on the content distribution information; and may publish information to store the particular content at the determined one or more locations.

In certain representative embodiments, the content distribution information may include any of: (1) a content type; (2) a number of requests for the content; and/or (3) one or more locations associated with the requests.

FIG. 7 is a flowchart illustrating a representative method of managing a namespace in a RV.

Referring to FIG. 7, the representative method may include, at block 710, a RV 240 that may establish a logical structure, as the namespace (e.g., representative namespace 400), in the RV 240. For example the logical structure may have a plurality of levels 410, 420, 430, 440, 450 and 460. At block 720, the RV 240 may may store and/or represent the attribute information in a lowest level 460 of the logical structure.

In certain representative embodiments, the RV 240 may set a highest level 410 of the logical structure, as a root level node of the logical structure; may set a lower level 420, 430, 440 or 450 of the logical structure with a plurality of lower level node, each lower level node being associated with the root level node of the logical structure; may set a next lower level 420, 430, 440, 450 or 460 of the logical structure with a plurality of next lower level nodes (for example, each next lower level node may be associated with one of the lower level nodes of the logical structure); and may set a lowest level 460 of the logical structure with a plurality of lowest level nodes (for example each lowest level node may be associated with one of the next lower level nodes of the logical structure). The RV 240 may store in or represent by one or more lower level nodes of the logical structure respectively different node identifiers. The RV 240 may store in or represent by a lowest level node associated with a respective one of the lower level nodes attribute information.

FIG. 8 is a flowchart illustrating a representative method for an Information-Centric Networking (ICN) network.

Referring to FIG. 8, the representative method 800 may include, at block 810, a Topology Manager (TM) 230 obtaining node identifier information of one or more servers 210 (e.g., surrogate servers) on the the ICN and network statisitics information (e.g., of the ICN network). At block 820, the TM 230 may publish the node identifier information to a first network entity (e.g., RM 250) and/or the network statistics information to a second network entity (e.g., sNAP 220).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a UE, WTRU, terminal, base station, RNC, or any host computer.

Moreover, in the embodiments described above, processing platforms, computing systems, controllers, and other devices including the constraint server and the rendezvous point/server containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, when referred to herein, the terms “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of any WTRU recited herein.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of” multiples of the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. A method of surrogate server management in an Information-Centric Networking (ICN) network, the method comprising:
subscribing, by a network entity (NE), to attribute information to be published;
obtaining, by the NE, the published attribute information;
determining, by the NE, based on the obtained attribute information, whether to activate a virtual machine (VM) to be executed in a surrogate server or to deactivate the VM executing in the surrogate server, wherein the surrogate server is dynamically selected at least based on network load and a geographic location of the surrogate server; and
publishing, by the NE to a second NE, a command to activate or deactivate the VM.

2. The method of claim 1, wherein:
the subscribing of the NE to attribute information includes subscribing to a subscope of a namespace available from a rendezvous server including any of: (1) server state information; (2) server statistics information; or (3) network statistics, and
the namespace is associated with a location of the NE for publication, the method further comprises:
obtaining, by the NE, node identifiers that are associated with the location of the NE.

3. The method of claim 2, wherein the obtaining of the published attribute information includes: obtaining any of: (1) the server state information associated with one or more servers or VMs of the ICN network; (2) server statistics information associated with the one or more servers or the VMs of the ICN network; or (3) network statistics of the ICN network from a Topology Manager.

4. (canceled)

5. The method of claim 1, wherein the determining of whether to activate or to deactivate the VM of the surrogate server includes determining, by the NE, whether to:
(1) activate the VM of the surrogate server to enable any of: (i) server mirroring by the surrogate server of a second surrogate server or (i) load balancing between two or more surrogate servers, or
(2) deactivate the VM of the surrogate server to disable any of: (i) the server mirroring by the surrogate server of the second surrogate server or (ii) the load balancing between the two or more surrogate servers.

6. The method of claim 1, wherein the determining of whether to activate or to deactivate the VM of the surrogate server includes:
comparing one or more network or server statistics to one or more thresholds and one or more server states to reference server states, as a set of comparison results; and
determining whether to activate the VM or whether to deactivate the VM, in accordance with the comparison results and one or more policies associated with the comparison results.

7. (canceled)

8. The method of claim 1, wherein:
the determining of whether to activate the VM of the surrogate server includes determining whether the second NE or another surrogate server is overloaded and/or whether a network segment in a vicinity of the second NE or the other surrogate server is congested based on the attribute information;
the publishing of the command to activate or to deactivate the VM includes publishing one or more commands to spin up one or more further surrogate servers at different locations in the ICN under the condition that any of: (1) the second NE or the other surrogate server is overloaded; or (2) the network segment in the vicinity of the second NE or the other surrogate server is congested; and
the determining of whether the network segment in the vicinity of the second NE is congested includes determining any of: (1) load information at surrogate servers served by the second NE; (2) latency of particular flows associated with the surrogate servers served by the second NE; or (3) error performance information associated with the surrogate servers served by the second NE.

9-10. (canceled)

11. The method of claim 8, wherein the publishing of the command to the second NE includes publishing the command to the second NE to activate one or more other VMs associated with the second NE on a condition that the vicinity of the second NE or a location at the second NE is locally congested such that load balancing is enabled between or among surrogate servers associated with the second NE.

12. The method of claim 1, further comprising:
determining whether a network segment in a region proximate to a vicinity of or in a location at the second NE is regionally congested; and
publishing a command to another NE to activate other VMs associated with the other NE on a condition that the region proximate to the vicinity of or in the location at the second NE is regionally congested such that load balancing is enabled between or among surrogate servers associated with different network entities.

13. (canceled)

14. The method of claim 1, wherein the obtaining of published attribute information includes obtaining, by the NE, content distribution information of a network segment associated with the second NE, the method further comprising:
determining one or more locations for storage of a particular content based on the content distribution information; and
publishing information to store the particular content at the determined one or more locations, wherein the content distribution information includes any of: (1) a content type; (2) a number of requests for the content; or (3) one or more locations associated with the requests.

15-20. (canceled)

21. A Network Entity (NE) configured to manage one or more surrogate servers in an Information-Centric Networking (ICN) network, the NE comprising:
a processor configured to subscribe to attribute information to be published; and
a transmit/receive unit configured to obtain the published attribute information,
wherein:
the processor is configured to determine, based on the attribute information, whether to activate a virtual machine (VM) to be executed in a respective one of the surrogate servers or to deactivate the VM executing in the respective one of the surrogate servers, wherein the respective one of the surrogate servers is dynamically selected at least based on network load and a geographic location of the respective one of the surrogate servers, and
the transmit/receive unit is configured to publish to a second NE, a command to activate or deactivate the VM.

22. The NE of claim 21, wherein:
the processor is configured to subscribe to a subscope of a namespace available from a rendezvous server including any of: (1) server state information; (2) server statistics information; or (3) network statistics;
the processor is configured to subscribe to the subscope of the namespace via a Topology Manager (TM) that is associated with a location of the NE; and
the transmit/receive unit is configured to obtain node identifiers that are associated with the location of the NE.

23. The NE of claim 22, wherein the transmit/receive unit is configured to obtain any of: (1) the server state information associated with one or more servers or VMs of the ICN network; (2) the server statistics information associated with the one or more servers or the VMs of the ICN network; or (3) the network statistics of the ICN network from the Topology Manager.

24-27. (canceled)

28. The NE of claim 21, wherein:
the processor is configured to determine any of: (1) whether the second NE or another surrogate server is overloaded; (2) whether a network segment in a vicinity of the second NE or the other surrogate server is congested based on the attribute information; (3) load information at surrogate servers served by the second NE; (4) latency of particular flows associated with the surrogate servers served by the second NE; or (5) error performance information associated with the surrogate servers served by the second NE; and
the transmit/receive unit configured to publish one or more commands to spin up one or more further surrogate servers at different locations in the ICN under a condition that the second NE or the other surrogate server is overloaded or the network segment in the vicinity of the second NE or the other surrogate server is congested.

29-30. (canceled)

31. The NE of claim 28, wherein the transmit/receive unit is configured to publish the command to the second NE to activate one or more other VMs associated with the second NE on a condition that the vicinity of the second NE or a location at the second NE is locally congested such that load balancing is enabled between or among surrogate servers associated with the second NE.

32. The NE of claim 21, wherein:
the processor is configured to determine whether a network segment in a region proximate to a vicinity of or in a location at the second NE is regionally congested; and
the transmit/receive unit is configured to publish a command to another NE to activate other VMs associated with the other NE on a condition that the region proximate to the vicinity of or in the location at the second NE is regionally congested such that load balancing is enabled between or among surrogate servers associated with different NEs.

33-39. (canceled)
